(19) United States
(12) Patent Application Publication
(10) Pub. No.: US 2008/0115245 A1
(43) Pub. Date: May 15, 2008

(54) Low nitrate vegetable and its cultivation system and method

(75) Inventors: Shu-Chin Chen, Ping Zhen City (TW); Chia-Yu Chen, Ping Zhen City (TW)

Correspondence Address: RABIN & Berdo, PC, 1101 14TH STREET, NW, SUITE 500, WASHINGTON, DC, 20005, US

(73) Assignee: Canyon Biotechnology Co. Ltd., Dongsang County (TW)

(21) Appl. No.: 11/594,772

(22) Filed: Nov. 9, 2006

(51) Int. Cl. A01H 5/00; A01G 31/00

(52) U.S. Cl. 800/298; 47/62 R

(57) ABSTRACT

The present invention uses specific cultivation system and method to produce vegetables with a nitrate nitrogen (NO₃—N) concentration below 450 ppm (NO₃—N (mg/kg)≦450 ppm). An advanced water cultivation system and a scheduled nutrient injection and removal method are used to achieve the specification of a nitrate nitrogen concentration less than 450 ppm. The nutrient supply and recycle system sets a time period prior to harvest to recycle nutrients and consume the nitrate nitrogen of the vegetables by supplying fresh water only, so that nitrate nitrogen remained in the vegetables can be consumed completely by the natural process of photosynthesis and the nitrate nitrogen concentration of these vegetables is much below those produced by traditional farming, water cultivation, organic cultivation or wildlife or those cannot achieve a low nitrate nitrogen under natural conditions. The invention is definitely a breakthrough on the quantitative control of harmful ingredients.

### BACKGROUND OF THE INVENTION

1. Field of the Invention

The present invention relates to a low nitrate vegetable and its cultivation system and method, and more particularly to a low nitrate vegetable and its cultivation system and method that adopt an advanced water cultivation system and a scheduled nutrient injection and removal method.

2. Description of the Related Art

Vegetables with high nitrate nitrogen (NO₃—N) concentration have bad effects on our health, and the high nitrate nitrogen (NO₃—N) concentration has been an issue for agricultural experts for long, and the agricultural industry still cannot provide any feasible solution to overcome this technical problem. Till now, no disclosure on the control of high nitrate nitrogen (NO₃—N) concentration of vegetables has been made or even mentioned about its technical development or breakthrough. Before the inventor of the present invention files a patent application for the present invention, others used genetic modification technologies and tried to change the genes and composition of agricultural products (including vegetables), but not too many people focus on the composites of vegetables that is harmful to human beings to conduct researches and experiments on the quantitative control. Furthermore, no scholar in the field of genetic modification have provided any convincing published theses, data, or theory for the questions on whether or not agricultural products produced by the genetic modification technology are harmful to human bodies, how genetic modification technology affects the agriculture or ecology and to what extent, and what are other unpredictable risks derived from the genetic modification technology. The answers to all these questions cannot be obtained in a short time. For simplicity, the nitrate nitrogen (NO₃—N) is also called nitrates in general.

### SUMMARY OF THE INVENTION

Therefore, it is a primary objective of the present invention to provide cultivation and production of a low nitrate vegetable, which does not employ the genetic modification or other genetic modification related technologies to achieve the result with a detected nitrate nitrogen (NO₃—N) concentration equal to or less than 450 ppm [NO₃—N (mg/kg)≦450 ppm], but the invention uses an advanced water cultivation system and a scheduled nutrient injection and removal method to grow vegetables with sufficient photosynthesis, and also produces a low nitrate vegetable by natural processes. The low nitrate vegetables produced by the present invention are vegetables that cannot maintain a low nitrate specification under natural conditions, and the invention is definitely a breakthrough on the quantitative control of harmful ingredients to human bodies. Up to now, no related technology, report, or thesis has been found yet.

As the society is evolved from fishing and hunting, pasturage, farming to recent two centuries, industrial revolutions and agricultural revolutions (green revolutions) accompanied with the industrial revolutions improve the yield of crops drastically. The drastic increase of crop production can overcome the hunger of a vast majority of population in the world Till now, people are able to accept the evaluated result of having more advantages than disadvantages of the agricultural revolutions (green revolutions), but the land overdeveloped and used in the agricultural revolution has deteriorated the soil quality, and the deterioration of soil quality forced farmers to use a tremendous amount of chemical fertilizers to improve the deteriorating agricultural conditions. The agricultural activities in such a vicious circle give rise to the bad effects such as the cultivated land soil acidification and fertility exhaustion more quickly. Furthermore, the traditional farming and cultivation require a huge amount of irrigating fresh water. Since the fresh water resource becomes very precious nowadays, a water cultivation method with a higher production yield becomes one of the most important cultivation methods for agricultural business runners. More particularly, the global temperature has risen 0.6□ quickly within 100 years in the 20^{th} century, and certain computer models simulate the change of global climates and predict that the global temperature will rise more than 3.3□ in this century. By then, the polar region will melt and the sea level will rise to force agricultural land to be decreased or vanished. Except Amazon and Congo Rivers, the water of the other five of the World's seven largest rivers becomes lesser and lesser, and dry-ups of the Yellow River in China have occurred 17 times in the past 50 years. The global warming results in more frequent typhoons and torrential rains (The statistics show that the rainfall in Taiwan is increased by approximately 300 mm, but the number of raining days is decreased by 28 days in 2005). The drastic change of climates in a short period definitely will disturb the regular pattern of rainfalls and the rainwater for nourishing traditional agricultural regions and will severely affect the traditional agricultural business operation and the harvest and price of agricultural products. Therefore, a water cultivation method with a high production yield becomes an option for improving the production value of the recent agricultural business. Although the water cultivation method can improve the foregoing shortcomings such as the decrease of cultivated land, the large consumption of irrigating fresh water, the deteriorated soil quality caused by extensively use of chemical fertilizers, the pollution of wastes discharged from water cultivation, and the adverse effect on the eutrophication of rivers and lakes. Further, it is found unexpectedly that the water cultivation vegetables often have a large quantity of remained nitrate nitrogen that may affect consumer's health. The prevent invention focuses on the aforementioned shortcomings of damaging environment, wasting fresh water resource, and producing unsafe vegetable by traditional farming, water cultivation or organic cultivation, so as to provide effective and feasible solutions and improvements.

### BRIEF DESCRIPTION OF THE DRAWINGS

The objective, shape, structure, characteristic and effect of the present invention will now be described in more detail with reference to the accompanying drawings that show various embodiments of the invention, in which:

FIG. 1 is a schematic view of a system employing the method of controlling nitrate nitrogen concentration of vegetables according to the present invention;

FIG. 2 is a schematic view of the layout of nutrient liquid supply and recycle system of the present invention;

FIG. 3 is a schematic view of the layout of water cultivation area of the present invention;

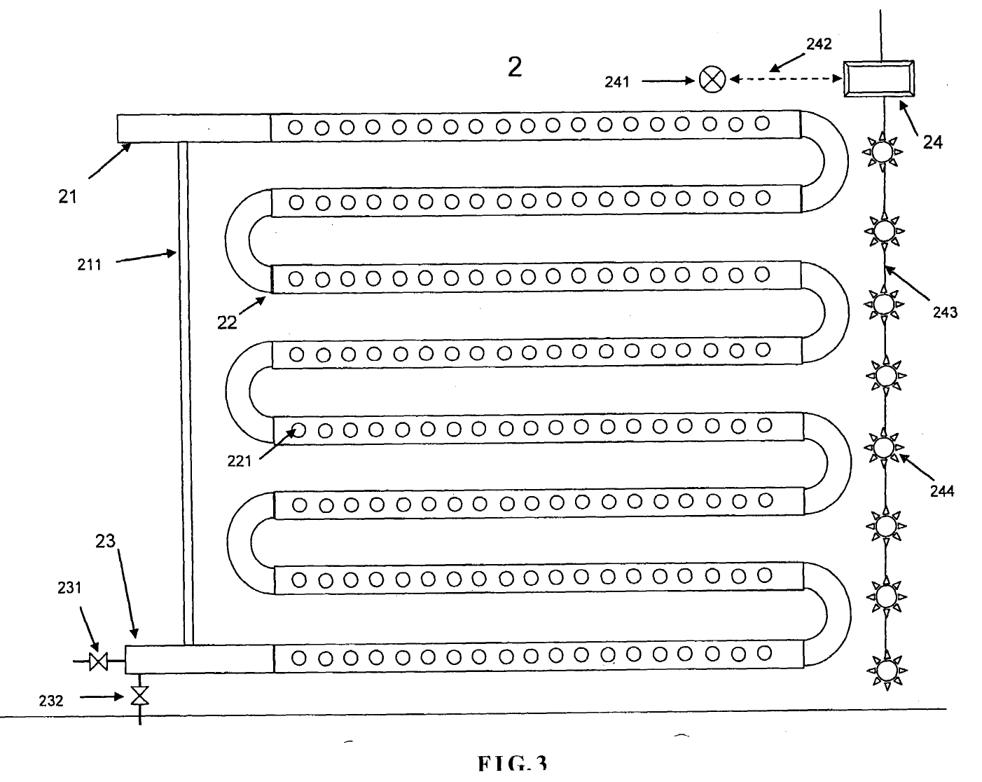

FIG. 4 is an enlarged view of a water cultivation pipe of the present invention; and

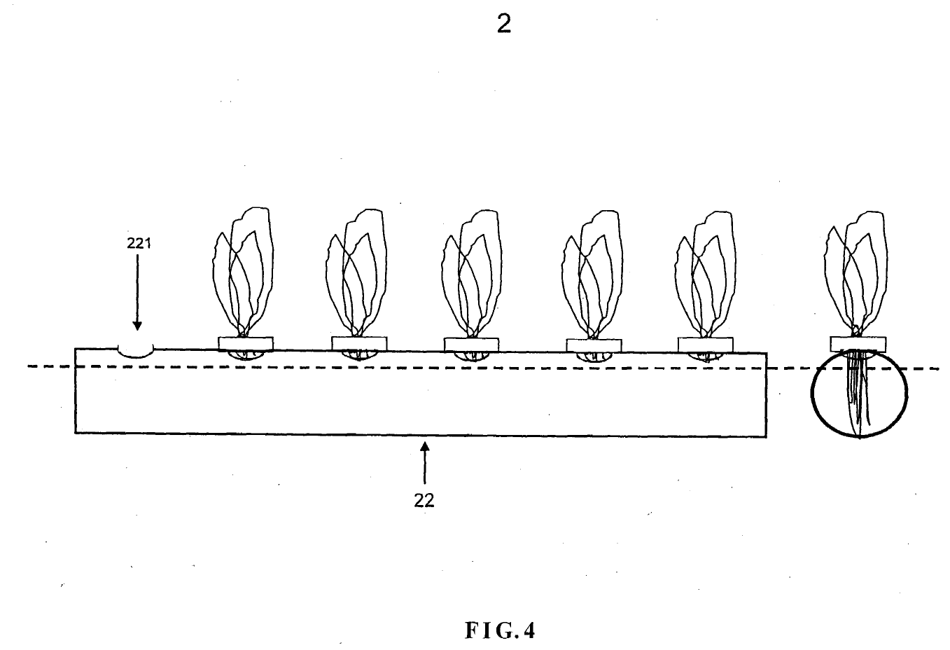

FIG. 5 is a schematic view of comparing the water consumption for the water cultivation of a prior art and the present invention.

### DETAILED DESCRIPTION OF THE PREFERRED EMBODIMENTS

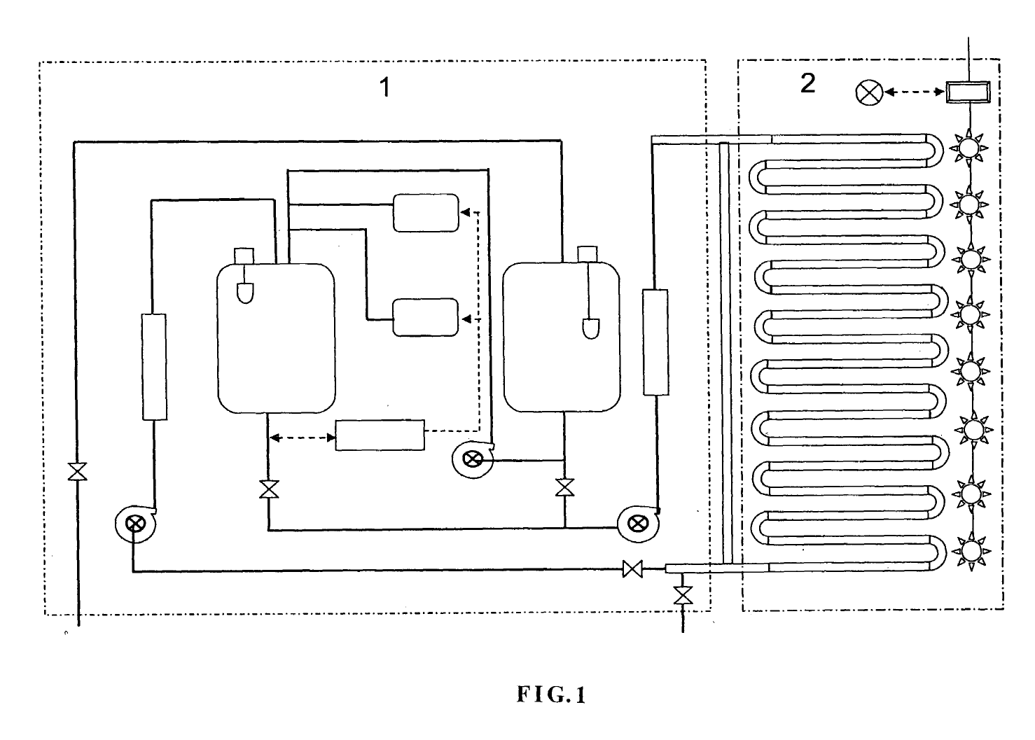

The present invention relates to a series of low nitrate vegetables produced by a specific cultivation method, and the detected nitrate nitrogen (NO₃—N) concentration of vegetables is below 450 ppm. The present invention controls the nitrate nitrogen concentration of vegetables by using an advanced water cultivation technology and a scheduled nutrient injection and removal method, which will be illustrated by the following preferred embodiment. Referring to FIG. 1, the method of the invention can control the nitrate nitrogen concentration of vegetables [NO₃—N (mg/kg)≦450 ppm], save irrigating fresh water, facilitate nutrient recycle and reuse, eliminate the discharge of waste liquid produced by the water cultivation, enhance the growing speed of vegetables, and increase the efficiency of growing vegetables per unit area. The present invention has the following features:

(1) The nitrate nitrogen concentration [NO₃—N (mg/kg)≦450 ppm] remained in the vegetables can be controlled properly.

(2) The nutrients can be recycled and reused easily.

(3) The irrigating water can be saved significantly.

(4) The nutrient EC value and pH value can be adjusted precisely.

(5) A multi-layer cultivation can be employed to increase the efficiency of land use effectively.

(6) The farming labor can be reduced greatly.

(7) Pests in the soil can be prevented or eliminated completely.

The method for controlling the nitrate nitrogen concentration of vegetables according to a preferred embodiment of the present invention adopts an advanced water cultivation technology that primarily uses water pipes to distribute, recycle and store nutrients easily, so that the nutrients in the water cultivation pipe can supply the nutrition for the growth of vegetables. If the pH value of the nutrient rises, this method will timely lower the pH value. If the nutrient EC value drops, this method will timely adjust the EC value of the nutrient, such that the nutrient ingredients is adjusted to the most suitable condition for the absorption by vegetables. The present invention has the features of saving irrigating water, preventing a discharge of waste liquids in the water cultivation, eliminating pollution caused by the eggs of parasites in the soil, controlling the nitrate nitrogen concentration, and thus the invention is definitely a breakthrough in agricultural cultivation technologies.

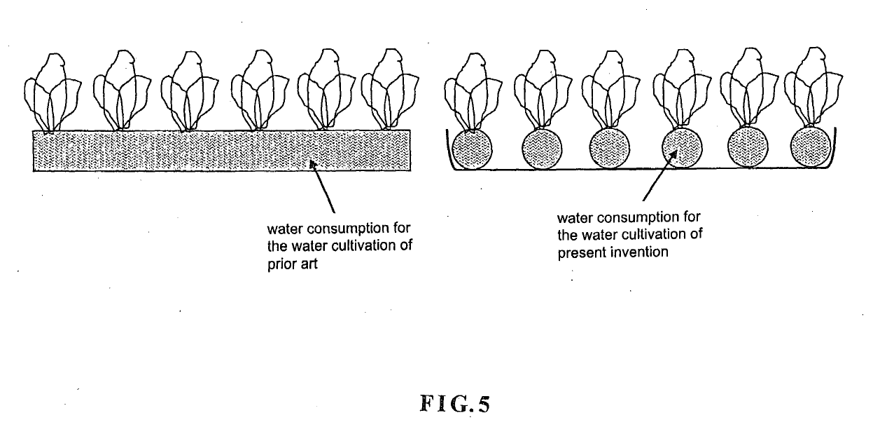

This embodiment makes use of the unique advantage of water pipes to effectively reduce the consumption of nutrients and fresh water and improve over the traditional water cultivation method as shown in FIG. 5 to facilitate the transmission, distribution and recycle of nutrients, so that the nutrient can be supplied to the vegetables required for the water cultivation as shown in FIG. 1. Further, the advanced water cultivation technology employs PVC water pipes as the base for the cultivation and features a convenient nutrient recycle. Thus, this embodiment can effectively prevent waste liquids from being discharged into rivers or lakes. After the nutrient recycle function of the invention is implemented, the invention can prevent improper discharges of waste liquids, and also can effectively control the concentration of nitrate nitrogen remained in vegetables below 450 ppm. The PVC water pipes employed by the advanced water cultivation technology as the basis for cultivation are made of an opaque material, and thus they can prevent direct sunlight from being projected onto the nutrient, and prevent the breeding of photophilic algae or fungi in the nutrients from competing with the growth of vegetables during the cultivation process in the first place, and the PVC water pipes also prevent any alkaline substance released from the algae or fungi into the nutrient, so as to maintain a stable pH value for the nutrient and avoid the pH value of the nutrient from rising which may lower the efficiency for the roots of vegetables to absorb the nutrient (The roots of the vegetables has the best absorbing efficiency if the pH value falls within the range of 5.5˜6.5).

In view of the description above, the method for controlling the nitrate nitrogen concentration of vegetables according to this embodiment has the following advantages over the traditional water cultivation or farming methods: (1) The irrigating water can be saved up to 70%; (2) No waste liquid of the water cultivation will be discharged; (3) The land will not be acidified; (4) The eggs of parasites in the soil can be prevented or eliminated; (5) The nitrate nitrogen concentration of vegetables can be reduced; and (6) The growth rate of vegetables can be improved. Thus, the present invention is definitely a breakthrough for the agricultural cultivation technologies.

The primary feature of this embodiment resides on improving the traditional farming and cultivation process that requires a large quantity of irrigating water for obtaining a better harvest. In a careful analysis of the consumption of irrigating water in a traditional farming and cultivation, it is found that not all of the irrigating water are absorbed by the vegetables, and the actual measurements and statistics show that only 100 c.c. per day is sufficient for the water demand of each vegetable during a growing cycle, but the quantity of irrigating water for the traditional farming and cultivation is approximately 200 c.c˜500 c.c. per day (depending on the water infiltration rate of the soil), and thus lots of precious fresh water resource are wasted. In general, 50%˜90% of the irrigating water for the traditional farming and cultivation is loss to the ground or evaporated by the solar heat. The waste of irrigating water in the traditional farming and cultivation must be stopped immediately since the fresh water resource becomes increasingly less. The vegetable cultivation process of the invention can save a large quantity of irrigating water, and the water demand will be only 25˜30% of that for the traditional farming and cultivation. The irrigating water and nutrients not absorbed by the vegetables can be recycled and reused.

The secondary feature of this embodiment resides on overcoming the shortcoming of the traditional water cultivation and prevents improper discharges of waste nutrients in the water cultivation. The nutrients for a general water cultivation cannot avoid direct sunlight, and thus it is inevitable to have bacteria and algae bred in the nutrients, and the sunlight and bacteria will expedite the decomposition (or fermentation) of the nitrates in the nutrients, and thus giving rise to a further temperature rise. The rise of temperature of the nutrient in the water cultivation is the main cause to a rotten root of the vegetables, and thus the frequent discharges and refreshing of waste liquids in a water cultivation become a routine for growing vegetables by water cultivation, and the rise of temperature is also a disaster to the eutrophication of rivers and lakes. Based on the foregoing reasons, the Authority of Agricultural Affairs in Taiwan does not encourage farmers to grow vegetables by water cultivation, although there is no law regulated for the water cultivation of vegetables yet. The nutrients used in the advanced water cultivation can be recycled and reused. The invention can completely overcome the problem of discharging waste nutrients in the water cultivation, and recycle and reuse the nutrients to effectively lower the operating cost.

The third feature of this embodiment resides on providing a cultivation method that can completely avoid applying chemical fertilizers to the soil or land, and thus can avoid the acidification or deterioration of the soil quality of the cultivated land. Since the soil cultivation cannot control a precise consumption of fertilizers or the wash offs by irrigating water or rainwater, and the fertilizers are lost into the soil for no reason, farmers worry that there is insufficient fertilizers applied, and usually use excessive fertilizers. The present invention applies the nutrients to the vegetables with a constant quantity at a regular scheduled time to meet the requirements at different stages and also adopts the advanced water cultivation method to supply nutrients to the roots of the vegetables, not only meeting the requirements for cost-effectiveness, but also avoiding an excessive use of chemical fertilizers that will cause acidification and deterioration to the soil quality of a cultivated land. In the present invention, the vegetable is not in contact with soil at all, and thus the invention can prevent contaminating the soil with the chemical fertilizers.

The fourth feature of this embodiment resides on improving the bad consequences resulted by the traditional water cultivation in an overall professional manner by preventing the nutrients from dipping the roots of vegetables during the water cultivation, so that the roots can be in contact with the air or breath. As a result, the nitrate nitrogen concentration of vegetables produced by water cultivation is much higher than that of the vegetables produced by soil cultivation, and exceeds an acceptable upper limit of nitrate nitrogen. Besides the roots of vegetables produced by water cultivation cannot breathe in the air or lack of oxygen (O₂), it also allows enzymes in the vegetable to effectively perform metabolism with the nitrate radical (NO₃⁻). Secondly, the concentration of nutrients in water cultivation is usually too high and exceeds the quantity bearable by the normal photosynthesis mechanism (metabolism) of vegetables produced by water cultivation, such that the stems and leaves of the vegetables grown by water cultivation accumulate excessive nitrate radicals (NO₃⁻) which cannot be transformed into amino acids in time, and finally composed into protein. The nitrate radical (NO₃⁻) is one of the elements that cannot be digested by humans, such that if excessive nitrate radicals (NO₃⁻) are taken into the digestive system of a human body, the nitrated radicals will be transformed into ammonium nitrite (NH₄NO₂) by the chemical reaction of enzymes in the digestive system, and ammonium nitrite (NH₄NO₂) is considered as a carcinogenic factor to a specific cancer in the medical field, and an excessive quantity of nitrate radicals is harmful to our health which is proved by clinical science. Nitrate radicals are also a dangerous factor for diseases such as the blue baby disease, and if a baby ingests too much nitrates, the nitrate radical (NO₃⁻) will enter into the baby's blood, so that the hemoglobins in the blood lose their capability of combining with oxygen, so that the blood shows a bluish purple color, which may cause dysnea and even suffocation. The nitrate radicals are also one of the carcinogenic factors to intestine and stomach cancers. Particularly, ammonium nitrites (NH₄NO₂) damage the hemoglobins in human blood or even expedite aging the cell functions. Developed countries have established standards and specifications for the nitrate nitrogen concentration in vegetables (Refer to Attachment 2) to protect consumers. For example, Germany has specified that the spinach products used in baby food should not contain a concentration of nitrate radicals (NO₃⁻) higher than 250 ppm [NO₃—N (mg/kg)≦250 ppm. The World Health Organization recommends us to take a safe dosage of less than 3.6 mg per kilogram of our body weight per day. For example, a person weighing 60 Kg should not take more than 500 ppm of nitrates a day.

At present, European countries sets a standard of below 2,000 ppm˜3,000 ppm for the upper limit of remained nitrate radical (NO₃⁻) for most vegetables, and People's Republic of China has a stricter standard of less than 450 ppm. For vegetables grown in Taiwan during winters, the quantity of nitrate radicals (NO₃⁻) remained in the vegetable usually exceeds 3,000 ppm˜4,000 ppm due to the long raining weather and short sunny days and excessive uses of fertilizers and the farmer's habits of harvesting the vegetables before dawn, but related governmental departments have not set any regulations or standards for the nitrate radicals (NO₃⁻) remained in vegetables. The present invention adopts a control standard adopted by the strictest country (People's Republic of China) which is NO₃—N (mg/kg)≦450 ppm. The specification for the nitrate nitrogen (NO₃—N) remained in vegetables adopted by the present invention is incomparable by anyone in the agricultural field in the world, and the invention is a breakthrough on controlling the constant quantity of harmful ingredients in vegetables.

It is noteworthy to point out that the nitrate radical (NO₃⁻) concentration is equal to the nitrate nitrogen (NO₃—N) concentration×4.43.

This embodiment of the invention focuses on the foregoing unsafe accumulated quantity of nitrate radicals (NO₃⁻) in the stems and leaves of vegetables for the improvement, so as to avoid excessive nitrate nitrogen (NO₃—N) remained in the stems and leaves of vegetables produced by traditional soil cultivation or water cultivation and prevent its adverse effect on human health. The roots of vegetables produced by general soil cultivations can breathe freely, because there is air flowing through gaps and crevices of the gravels in the soil. After the roots of the vegetables produced by soil cultivation absorb oxygen (O₂) into the vegetables, the nitrate nitrogen (NO₃—N) is consumed more quickly, and thus excessive accumulation of nitrate radicals (NO₃⁻) (approximately 1,500 ppm˜2,000 ppm) can be avoided. If the vegetables produced by soil cultivation is harvested at the period of rainy days, the photosynthesis will be insufficient and more nitrate radicals (NO₃⁻) will be remained in the stems and leaves of the soil cultivated vegetables, and there is a serious excessive quantity of (approximately 2,500 ppm˜3,500 ppm). In the vegetables produced by traditional water cultivations, the roots are dipped into the nutrients for a long time and thus the roots cannot breathe to obtain oxygen (O₂) directly. Unlike the vegetables produced by soil cultivation and harvested before stopping using the fertilizers, the concentration of nitrates in the nutrient is usually too high, and thus the supply of nutrients of the water cultivation cannot be controlled in different stages. Therefore, the stems and leaves of vegetables produced by water cultivation have accumulated excessive nitrate radicals (NO₃⁻) (approximately 3,000 ppm˜4,500 ppm). The quantity of nitrate nitrogen (NO₃—N) remained in the vegetables is too high, which refers to the concentration of nitrate radicals (NO₃⁻) stored in the stems and leaves of the vegetables exceeding the standard of 4,500 ppm. In the actual experiments and verifications of the control method according to this embodiment, the quantity of nitrate nitrogen (NO₃—N) accumulated in sample vegetables can be controlled, and the quantity of nitrate nitrogen (NO₃—N) remained in the sample vegetable (whole piece) is verified. The tested vegetable has to go through a drying process that will damage the chlorophyll in the vegetable in order to test the nitrate nitrogen, and the weights of the sample vegetable before drying and after drying are measured and compared to have a ratio of 4.8%), and the total directly quantity of remained nitrate nitrogen is converted and found to be 358 ppm. (Refer to Attachment 1 for analysis report conducted by the Agriculture & Natural Resources Institute of National Chung Hsing University) and also refer to NIEA W415.52B for the inspection method. The concentration is much lower than the maximum allowable standard of nitrates in vegetables as set forth by European Union (see details in Attachment 2) and also much lower than the standard of the nitrate nitrogen remained in the vegetables produced by general soil cultivation and organic cultivation.

The fertilizer required for the traditional farming and cultivation vegetable is nitrogen (N₂), and its source is urea (CO(NH₂)₂), but the evolving mechanism of the roots of a general plant cannot directly absorb urea [CO(NH2)2] except a small number of root nodules of plants. The nitrogen (N₂) element in the cycle of nature must go through the bacteria or fungi in the soil, and the urea [CO(NH₂)₂] in the nitrogen (N₂) element can be converted into ammonia (NH₃) or nitrate. However, the ammonia (NH₃) or nitrate goes through the “nitrite nitrobacteria” fermentation and is decomposed into nitrite radicals (NO2-), and finally the nitrobacteria will decompose the nitrite radicals (NO2⁻) for the second time and the nitrite radicals (NO2⁻) are converted into the nitrate radical (NO₃⁻). After the conversion, the nitrogen (N₂) element in the urea [CO(NH₂)₂] is decomposed completely into nitrate radicals (NO₃⁻) that can be absorbed by the roots of a general plant or a vegetable. The nitrate radical (NO₃⁻) is converted into amino acid and carbon dioxide (CO₂) by photosynthesis, and finally the amino acid is composed into usable proteins for the vegetables, and the carbon dioxide (CO₂) will be discharged. The mechanism of its conversion sequentially includes the decomposition of urea [CO(NH₂)₂] into ammonia (NH₃) by bacteria or fungi for the first time (fermentation) and then decomposed by special bacteria in the soil for the second time (fermentation), and the ammonia (NH₃) is converted into nitrate radicals (NO₃⁻), and the nitrate radical (NO₃⁻) can be absorbed by a vegetable and converted into amino acid, and finally gone through the photosynthesis to compose the amino acid into the usable proteins stored in the stems and leaves of the vegetable. In the nature, only some of the root modules of the plants can live with a group of nitrogen fixation bacteria and absorb the ammonia (NH₃) element in the nature directly or the nitrogen (N₂) element in air. The ammonia (NH3) element is transformed into chemicals absorbable by plants, and such process is called nitrification, and its chemical formula is given as follows: (NO₄⁺)→(nitrite bacteria decomposition)→(NO₂⁻)→(nitrobacteria decomposition)→(NO₃⁻).

The nutrient (or fertilizer) used for vegetables produced by traditional water cultivations includes nitrogen, phosphorous, potassium, calcium, magnesium, and sulfur etc, wherein the main source of a nitrogen (N₂) fertilizer comes from mixing the nitrates such as calcium nitrate (Ca(NO₃)₂) and potassium nitrate (K(NO₃)) directly into the nutrient. Since the roots of vegetables produced by water cultivation is dipped into the nutrient for a long time to absorb the nitrate radicals (NO₃⁻) continuously and a metabolism (or photosynthesis) cannot be conducted effectively, therefore the nitrate nitrogen concentration remained in the stems and leaves of vegetables produced by water cultivation must be very high. In a solution for controlling the nitrate radical (NO₃⁻) concentration in the nutrient effectively or setting up the supply quantity at each growing stage of the vegetables, the amount of sunlight, ambient temperature, and different growing stages of the vegetable are used for timely adjusting the supply quantity or concentration of the nutrient. For example, the nitrate radical (NO₃⁻) concentration in the nutrient is slightly higher under the direct sunlight for a long time, so as to expedite the growth of the plants or vegetables. Due to the good photosynthesis, the vegetables can quickly absorb and convert the nitrate radicals (NO₃⁻) into amino acids and finally the amino acids are polymerized into proteins. On the other hand, the nitrate radical (NO₃⁻) concentration in the nutrient is slightly lower in cloudy or rainy days. To avoid excessive nitrate radicals (NO₃⁻) remained in the stems and leaves of vegetables produced by water cultivation due to insufficient photosynthesis, the nitrate radical (NO₃⁻) entering a human body and goes through a digestive system for a digestion will be transformed into harmful ammonium nitrite (NH₄NO₂). The present invention overcomes the foregoing shortcomings of the vegetables produced by water cultivation by specifying the rules of stopping the supply of nutrients (nitrates) to the vegetables in a time period (such as certain days) before harvesting the vegetables, and only fresh water is supplied for the basic needs of the vegetables. The scheduled nutrient injection and removal method according to a preferred embodiment of the present invention allows the vegetables to maintain its basic metabolism function, but it also forces the vegetables to store nitrate radicals (NO₃⁻) in the stems and leaves of the vegetables before harvesting the vegetables, and the nitrate radicals are transformed into useful amino acids, so that the vegetable can go through sufficient photosynthesis (the cumulative light is 900,000 LUX or above), and the amino acids in the vegetables are transformed into proteins stored in stems and leaves of the vegetable, in hope of thoroughly improving the vegetables (produced by water cultivation, soil cultivation or organic cultivation) usually having a high nitrate radical (NO₃⁻) concentration (which exceeds 4,500 ppm) as shown in Attachment 2. Based on the above reasons, we know that some of the different vegetables sold in the market contain an excessively high concentration of nitrate radicals (NO₃⁻) mainly because the vegetables absorb excessive nitrate radicals (NO₃⁻), or the vegetables conduct photosynthesis (6CO₂+6H₂O→C₆H₁₂O₆+6O₂↑) with insufficient time or strength for a long time, so that the vegetable cannot produce sufficient ATP enzymes, and the vegetable cannot successfully and effectively transform the absorbed nitrate radicals (NO₃⁻) into amino acids or composed into proteins. In other words, the vegetable cannot consume or transform the accumulated nitrate radicals (NO₃⁻) into amino acids or compose the nitrate radicals (NO₃⁻) into proteins before the vegetable is harvested.

The method for cultivating a low nitrate vegetable (NO3-N (mg/kg)≦450 ppm) as shown in FIG. 1, the system for controlling the specific natural composition of a vegetable comprises a nutrient supply and recycle system 1 and a water cultivation area 2.

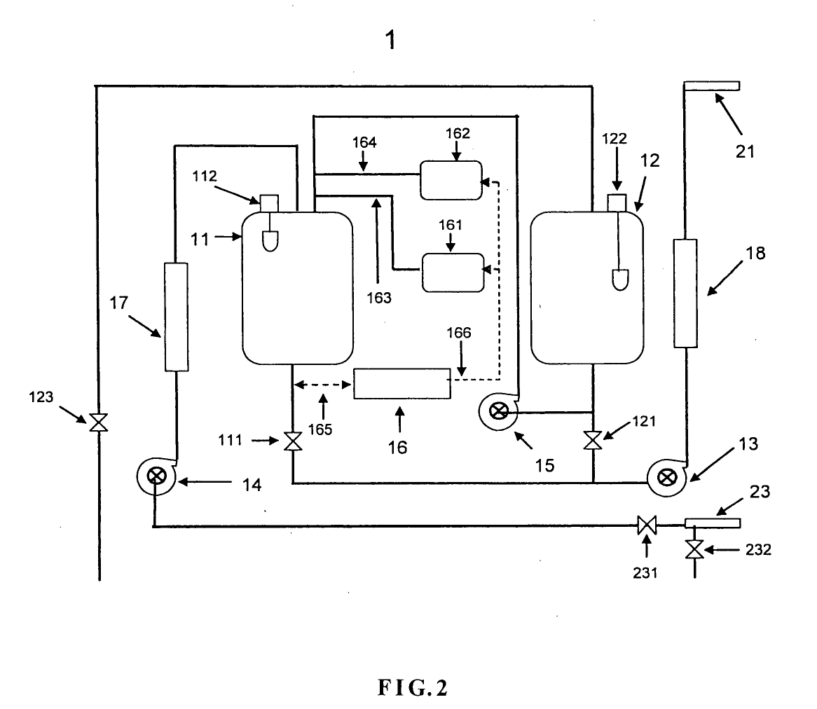

Referring to FIG. 2 for the preferred embodiment of the present invention, the nutrient supply and recycle system 1 aims at the supply and recycle of nutrients in vegetables grown at the water cultivation area 2, and monitors the EC value and the pH value of nutrients in the vegetables grown in the water cultivation area 2 all the time and adjusts the EC value or pH value of the nutrient when needed, so that the vegetables in the water cultivation area 2 can obtain appropriate and sufficient nutrition for a fast growth of vegetables and achieve an enhanced growing efficiency per unit area. If the vegetable is grown to the ready-to-harvest stage, the nutrient supply and recycle system 1 recycles the nutrient in a specific time period (such as 72 hours) before harvesting the vegetables, and only fresh water is supplied to maintain the basic biological requirements for the vegetables in the water cultivation area 2, so that the vegetable grown in the water cultivation area 2 can consume (or transform) the nitrate nitrogen accumulated in the vegetable completely by the natural process of photosynthesis, so as to successfully cultivate a health-oriented super low nitrate vegetable.

Further, the nutrient supply and recycle system 1 comprises a nutrient storage barrel 11, an irrigating water storage barrel 12, a nutrient boosting pump 13, a nutrient recycle pump 14, a nutrient regulating pump 15, an EC/pH value detector/controller 16, an ultraviolet disinfecting lamp 17 and a precision filter 18. The nutrient liquid level controller 112 is installed at the top of the nutrient storage barrel 11 for controlling a normal capacity of the nutrient storage barrel 11 and providing sufficient containing space when it is necessary to recycle the nutrients. The nutrient control valve 111 is installed to the outlet at the bottom of the nutrient storage barrel 11 for turning on or off the supply of the nutrient. The nutrient boosting pump 13 is installed between the nutrient storage barrel 11 and a nutrient supply pipe 21 for boosting the nutrient, such that the nutrient is passed through the precision filter 18 to filter foreign matters and then sent to the porous water cultivation pipe 22 for growing vegetables. An irrigating water level controller 122 is installed at the top of the irrigating water storage barrel 12 for controlling the normal capacity of the irrigating water storage barrel 12, and an irrigating water control valve 121 is installed at an outlet disposed at the bottom of the irrigating water storage barrel 12 for turning on or off the supply of irrigating water. If the irrigating water control valve 121 is turned on, then the nutrient control valve 111 will be turned off. By then, fresh water is supplied to the area of porous water cultivation pipes 22, such that the vegetable conducts a natural process of photosynthesis to consume (or transform) the nitrate nitrogen remained in the vegetable; on the other hand, nutrient is supplied to the area of porous water cultivation pipes 22, to facilitate a rapid growth of vegetables. The nutrient recycle pump 14 boosts the nutrient flowing back from the nutrient recycle pipe 23, such that after the nutrient is passed to an ultraviolet disinfecting lamp 17 and disinfected, the nutrient is sent to the nutrient storage barrel 11 for storage and future use. The EC/pH value detector/controller 16 is installed at an external side of the nutrient storage barrel 11 and an EC/pH value detection circuit 165 is connected to the outlet of the nutrient storage barrel 11 for detecting the change of EC value and pH value of the nutrient anytime, and the transmission through the EC/pH control circuit 166 controls the movement of the EC liquid container 161 or pH liquid container 162 to adjust the EC value or pH value of the nutrient according to instructions. If the EC liquid container 161 or pH liquid container 162 receives a signal from the EC/pH value detector/controller 16, the EC liquid container 161 or pH liquid container 162 will start injecting the EC liquid or pH liquid into the EC liquid injection pipe 163 or pH liquid injection pipe 164 into the nutrient storage barrel 11 to mix with the nutrient, so that the EC value and pH value of the nutrient can be maintained within a specific standard. If the EC value or pH value rises, the nutrient regulating pump 15 will be operated to draw fresh water from the irrigating water storage barrel 12 to the nutrient storage barrel 11 to lower the EC value or pH value of the nutrient. If the water level of the irrigating water storage barrel 12 is too low, then the irrigating water control valve 123 will be opened to fill fresh water into the irrigating water storage barrel 12 for future use.

The water cultivation area 2 comprises four major parts: a nutrient supply pipe 21, a porous water cultivation pipe 22, a nutrient recycle pipe 23 and an enhanced artificial light illuminating equipment 24. The nutrient supply pipe 21 and the nutrient balance pipe 211 are provided for quickly filling up the nutrient supplied from the nutrient boosting pump 13 to a predetermined level of nutrient in the area of porous water cultivation pipes 22 to facilitate the rapid growth of vegetables or using the irrigating fresh water supplied by the nutrient boosting pump 13 to replace the originally filled-up nutrient at a specific date before harvesting the vegetable, so that the vegetable can maintain its basic biological functions and use the natural process of photosynthesis to quickly consume (or transform) the nitrate nitrogen accumulated in the vegetables. The porous water cultivation pipe 22 includes a series of plurality of circular cultivation holes 221 disposed orderly, linearly and equidistantly at the top of the porous water cultivation pipe 22, such that the roots of vegetables planted thereon can be passed through one of the series of plurality of circular cultivation holes and 221 and extended into the porous water cultivation pipe 22 for absorbing nutrients for a rapid growth, or at a specific time period before the harvest, only irrigating fresh water are absorbed to maintain the basic biological needs of the vegetables, so that the vegetable conduct a natural process of photosynthesis to consume (or transform) the nitrate nitrogen accumulated in the vegetables and produce vegetables with a nitrate nitrogen concentration below 450 ppm. However, if there are successive rainy or cloudy days or a serious lack of sunshine during a specific period for stopping the supply of nutrient before the harvest according to the foregoing method and the total quantity of sunlight received by vegetables each day is less than 300,000 LUX (which refers to the total sunlight received in this embodiment), the enhanced artificial light illuminating equipment 24 will be turned on, so that light energy is provided to the area of the porous water cultivation pipe 22 to make up the light to 300,000 LUX artificially. Light is detected by a photoelectric sensor 241, and a signal is sent from an optical signal transmission circuit 242 to the enhanced artificial light illuminating equipment 24 to compute statistics for the total cumulative light energy within 12 hours. If the statistics of the total light energy is insufficient, the 12-hour nighttime lighting (which is 15,000 LUX./hr. in this embodiment) is used to make up the required total, then a current will be transmitted through a power transmission line 243 to a high performance mercury lamp set 244, such that the high performance mercury lamp set 244 is turned on for making up the deficiency of light energy, and the vegetables can conduct a natural process of photosynthesis by the energy of artificial lighting to consume (or transform) the nitrate nitrogen accumulated in the vegetables. Therefore, vegetables healthy to human bodies can be harvested everyday, and a low nitrate vegetable NO₃—N (mg/kg)≦450 ppm incomparable by vegetables grown under natural conditions or by traditional cultivation technologies will not be affected by the change of climates. The foregoing artificial complementary lighting system not only can be operated in special poor weather conditions, but also can make up the deficiency of sunlight of the day. The present invention can achieve the effect of saving energy instead of unlimitedly starting the artificial complementary lighting system or waste unnecessary precious energy source. The nutrient recycle pipe 23 is interconnected with the nutrient recycle pump 14 through the nutrient recycle valve 231 and normally set to the open state for facilitating the circulation of nutrients and supplementing the EC or pH value adjusting liquid. If the system is set to a non-circulating state, then the nutrient recycle valve 231 will be turned off, while the drain valve 232 is set to an open state for discharging water. The irrigating water used in the area of porous water cultivation pipes 22 is discharged to a water treatment equipment (not claimed in this invention) and goes through the disinfecting, sterilizing and filtering processes for its reuse. The function of controlling the nitrate nitrogen concentration of vegetables can be accomplished by the assembly and description of the foregoing elements and numerals, so as to cultivate vegetables healthy to human bodies and having a low nitrate concentration [NO₃—N (mg/kg)≦450 ppm] which is comparable by the vegetables grown in natural conditions or by traditional cultivation technologies.

The method for controlling the nitrate nitrogen concentration of vegetables according to the present invention is a creation that utilizes technological ideas of natural laws and its mechanism adopts the idea of the present invention. The advanced water cultivation system in conjunction with the scheduled nutrient injection and removal method force the vegetable to conduct a natural process of photosynthesis at a specific time period before harvest to consume (or transform) the nitrate nitrogen (NO₃—N) accumulated in the vegetables. In other words, the vegetable can recycle nutrients and irrigate vegetables with fresh water instead of nutrients at a specific time period before harvest. The scheduled nutrient injection and removal method in accordance with the present invention force the vegetables to consume (or transform) nitrate nitrogen accumulated in the vegetables, and its formula is given below: (NO₃⁻)→(photosynthesis Transformation)→(Amino Acid)→(photosynthesis Composition)→(Protein).

It is noteworthy to point out that the total cumulative quantity of light energy during the period of interrupting the supply of nutrients to vegetables is equal to or greater than 900,000 LUX. The interrupt period is set to 72 hours before harvest, and the nitrate nitrogen concentration detected in the produced vegetables is equal to 358 ppm. [NO₃—N (mg/kg)≦358 ppm.]. Refer to NIEA W415.52B for the inspection method and the inspecting institute is the Agriculture and Natural Resources Institute of National Chung Hsing University.

The foregoing embodiment of the invention is given for the purpose of illustration of the present invention and not intended to limit the scope of claims of the present invention, and various modifications and similar arrangements and procedure such as the method for lowering the high nitrate nitrogen (NO₃—N) concentration of vegetables and cultivating a low nitrate vegetable, regardless of using the “Intermittent nutrient supply method” or “Lowering nutrient concentration method” or even the energy-consuming “Artificial lighting method” to achieve the same effects, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and thus is duly submitted for the patent application.

What is claimed is:

1. A series of low nitrate vegetables, with a detected nitrate nitrogen (NO₃—N) concentration less than 450 ppm [NO₃—N (mg/kg)≦450 ppm], characterized in that the low nitrate vegetables are cultivated by a method to lower the nitrate nitrogen concentration of the vegetables, and the series of vegetables are cultivated by using an advanced water cultivation system in conjunction with a scheduled nutrient injection and removal method.

2. A low nitrate vegetable cultivation system, comprising: a nutrient supply and recycle system and a water cultivation area.

3. A method for cultivating low nitrate vegetables, comprising: planting a series of vegetables in a water cultivation area; using a scheduled nutrient injection and removal method to change a nutrient recycle to supplying fresh water only, after the series of vegetables are grown within a specific time period prior to harvest, so that the series of vegetables can consume the nitrate nitrogen remained in the vegetables effectively by a natural process of photosynthesis, so as to achieve a series of vegetables with a nitrate nitrogen concentration lower than 450 ppm.

4. The low nitrate vegetable cultivation system of claim 2, wherein the nutrient supply and recycle system comprises: a nutrient storage barrel, an irrigating water storage barrel, a nutrient boosting pump, a nutrient recycle pump, a nutrient regulating pump, an EC/pH value detector/controller, an ultraviolet disinfecting lamp and a precision filter.

5. The low nitrate vegetable cultivation system of claim 2, wherein the water cultivation area comprises a nutrient supply pipe, a porous water cultivation pipe, a nutrient recycle pipe and an enhanced artificial light illuminating equipment.

6. The low nitrate vegetable cultivation system of claim 4, wherein the nutrient storage barrel comprises a nutrient control valve and a nutrient liquid level controller.

7. The low nitrate vegetable cultivation system of claim 4, wherein the irrigating water storage barrel comprises: an irrigating water control valve and an irrigating water level controller.

8. The low nitrate vegetable cultivation system of claim 4, wherein the EC/pH value detector/controller comprises: an EC liquid container, a pH liquid container, an EC liquid injection pipe, a pH liquid injection pipe, an EC/pH value detection circuit and an EC/pH control circuit.

9. The low nitrate vegetable cultivation system of claim 5, wherein the nutrient supply pipe comprises a nutrient balance pipe.

10. The low nitrate vegetable cultivation system of claim 5, wherein the porous water cultivation pipe comprises a series of plurality of circular cultivation holes.

11. The low nitrate vegetable cultivation system of claim 5, wherein the nutrient recycle pipe comprises a nutrient recycle valve and a drain valve.

12. The low nitrate vegetable cultivation system of claim 5, wherein the enhanced artificial light illuminating equipment comprises a photoelectric sensor, an optical signal transmission circuit, a power transmission line and a high performance mercury lamp set.
